(19) United States
(12) Patent Application Publication
(10) Pub. No.: US 2013/0196721 A1
(43) Pub. Date: Aug. 1, 2013

(54) WIRELESS HEADSET

(71) Applicants: William Waterman, Maple Grove, MN (US); Ronald A. Carter, Farmington, UT (US); Bradley J. Stringer, Farmington, UT (US); Megan Waterman, Minneapolis, MN (US)

(72) Inventors: William Waterman, Maple Grove, MN (US); Ronald A. Carter, Farmington, UT (US); Bradley J. Stringer, Farmington, UT (US); Megan Waterman, Minneapolis, MN (US)

(73) Assignee: Aloft Technologies, Inc., Maple Grove, MN (US)

(21) Appl. No.: 13/558,565

(22) Filed: Jul. 26, 2012

Related U.S. Application Data
(60) Provisional application No. 61/511,903, filed on Jul. 26, 2011.

(51) Int. Cl. H04M 1/05

(52) U.S. Cl. CPC H04M 1/05
USPC 455/575.2

(57) ABSTRACT

A wireless headset can include a headset frame, a wireless transceiver, and an in-ear speaker. The wireless transceiver can be coupled to the headset frame and can be configured to communicate with a base station. The in-ear speaker can be coupled to the wireless transceiver for converting electrical signals into sound waves.

The present application claims the benefit of U.S. Provisional Patent Application No. 61/511,903, filed on Jul. 26, 2011, the entirety of which is incorporated herein by reference.

### BACKGROUND

Engines used to propel aircraft and the airflow around aircraft can generate fairly significant noise, making listening to conversations difficult for pilots and passengers. Furthermore, pilots use radio equipment to communicate with air traffic controllers and other pilots so they can safely navigate their aircraft. This high noise environment can make communicating difficult. The ambient or environmental noise with smaller aircraft can even be greater due to limited sound absorption and insulation used. Pilots often use a headset with a microphone and ear seals with speakers to reduce the noise around the pilot's ear, allowing the pilot to better communicate with air traffic controllers and other pilots. Furthermore, in addition to aircraft settings, there are other conditions where radio communication in high noise environments is useful.

### SUMMARY

The present disclosure is drawn to various headsets, including wireless headsets, for use in typically high noise environments. In one example, a wireless headset can comprise a headset frame a wireless transceiver coupled to the headset frame, and an in-ear speaker. The wireless transceiver can be configured to communicate with a base station and the in-ear speaker can be coupled to the wireless transceiver for converting electrical signals into sound waves.

In another embodiment, a wireless headset can comprise a headset frame and a wireless transceiver coupled to the headset frame, wherein the wireless transceiver is configured to communicate with a base station. Also included is a speaker configured for placement within or near the ear and is coupled to the headset frame for converting electrical signals into sound waves. A codec module can also be in communication with the wireless transceiver to convert a received signal generated by the wireless transceiver into an amplified signal input for the speaker.

In another example, a wireless headset can comprise a headset frame, and a pair of speakers coupled to the headset frame and configured for placement within ear canals of a user. A wireless transceiver can be coupled to the headset frame, wherein the wireless transceiver is configured to communicate with a base station and to convert electrical signals into sound waves at the pair of speakers. The headset will typically consume less than 20 milliamp-hour of energy in full operational mode with the wireless transceiver receiving or transmitting signals and the speakers emitting sound waves.

In another embodiment, a wireless headset can comprise a headset frame, and a speaker coupled to the headset frame and configured for placement within an ear canal of a user. A wireless transceiver can be coupled to the headset frame, wherein the wireless transceiver is configured to communicate with a base station and configured for converting electrical signals into sound waves at the speaker. Furthermore, the speaker can be positioned at least partially within a foam insert for substantially sealing with the ear canal for noise attenuation, e.g., a tapered foam insert. In one example, this type of passive noise reduction provides at least 30 dBA noise attenuation within the frequency range of 4 k to 6 k Hertz (Hz) in a high noise environment.

In yet another example, a headset for two-way communication (wired or wireless) can comprise a headset frame with a middle portion configured to wrap around a back of a user's head, and an ear support connected to the middle portion and configured to rest over an ear of the user's head. The ear support includes an end portion extending downwardly generally in front of the ear. A pair of in-ear inserts cam be attached to the headset frame, each being configured and positioned for placement within an ear canal. At least one speaker can be positioned on the headset for delivering sound to the ear inserts. Also, an adjustable microphone boom can be attached to the end portion of the headset frame. In this embodiment, the headset frame is swivelable at or near the ear support and is configured to rotate about 90 degrees with respect to the headset frame, thereby enabling the wireless headset to fold into a substantially flat configuration. In one example, the rotation can be about 180 degrees to allow for converting the headset between a left-handed microphone boom and a right-handed microphone boom.

### DESCRIPTION OF THE DRAWINGS

FIG. 1 is a perspective view of a wireless headset in accordance with an example of the present disclosure;

FIG. 2 is a perspective view of a wireless headset with in-ear speakers in accordance with an example of the present disclosure;

FIG. 3 is a perspective view of a wireless headset with a speaker box and acoustic tubes in accordance with an example of the present disclosure;

FIG. 4 is a view of an exploded view of transceiver housing assembly in accordance with an example of the present disclosure;

FIGS. 5A and 5B depict perspective and cross-sectional views, respectively, of a swivel joint in accordance with an example of the present disclosure;

FIG. 6 is a schematic diagram of a transceiver housing assembly in accordance with an example of the present disclosure; and

FIG. 7 is a perspective view of a wireless aviation transceiver module in accordance with an example of the present disclosure.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent a corresponding element of the same or similar embodiment. Numbers provided in flow charts and processes are provided for clarity in illustrating steps and operations and do not necessarily indicate a particular order or sequence.

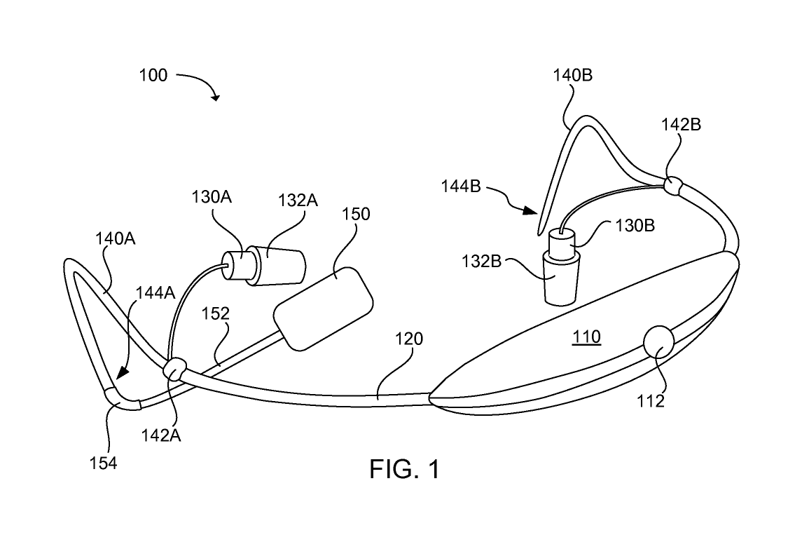

FIG. 1 illustrates a lightweight headset 100 which can be used in a high noise environment. The examples that follow illustrate how the headset can be used in the aviation environment, but the headset can be used in other high or low noise environments for two-way communication, including manufacturing environments, factories, warehouses, restaurants, racing, or other environments. The lightweight headset can improve a pilot's comfort in wearing a headset over other more cumbersome and headsets. For example, the lightweight headset of the present disclosure can reduce stress on the ears and head due to weight on the user while wearing the headset, and reduce the weight of the equipment and gear transported by the user. For example, the lightweight headset can weight less than about 2 ounces.

The headset 100 can include a transceiver, either wired or wireless, that can communicate with a base station. In one example, the wireless transceiver can transmit and receive a frequency modulated (FM) radio signal. The FM signal can have a frequency band from about 300 MHz to about 5.6 GHz, such as 900 MHz, 1.9 GHz, 2.4 GHz, etc. In one example, the FM signal can have an ultra high frequency (UHF), which can range between 300 MHz and 3 GHz. Amplitude modulation (AM) is often used in aviation radio equipment. An FM radio signal can provide greater reliability than an AM signal and reduce the effects of signal fading associated with an AM signal. Furthermore, the wireless transceiver can have a low transmission power which can provide reliable communication within a range of 10 to 50 feet from a base station. Low transmission power can reduce the power consumption on the electrical storage device and provide a longer duration on a single charge or use of the electrical storage device.

A low transmission power device can share a frequency band with other low transmission power devices because the signal from one device may not have the signal strength to cause interference or noise to another device some distance away at a different geographical location. Additionally, a low transmission power device can have fewer Federal Communications Commission (FCC) regulations related to the specifications of the transmitting device, which can reduce the cost of manufacturing.

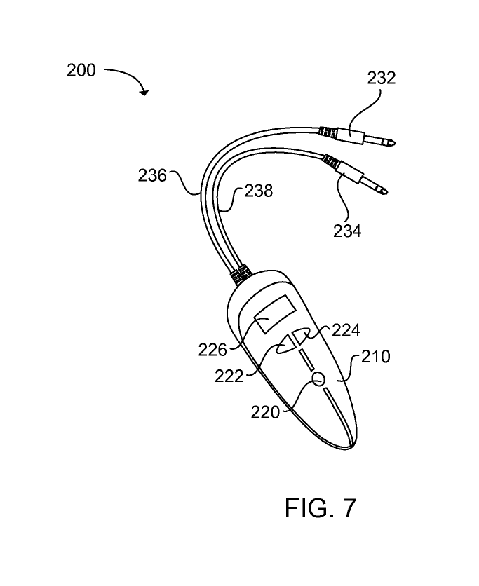

To further illustrate the low power embodiments of the present disclosure, the wireless transceiver and speaker of the lightweight headset can have a low power usage and operate with less than 20 milliamp-hour (mAh) of energy in full operational mode with the wireless transceiver receiving or transmitting signals and the speaker emitting sound waves. Alternatively, the headset can consume from about 0 to about 15 milliamp-hour in operational mode. In another example, the headset can be run using a triple A (AAA) or even a quadruple A (AAAA) battery (one or more). The headset may also consume less than 30 milliwatts of power in full operational mode. Alternatively, the headset can consume from about 0 to about 22 milliwatts of power in operational mode. The base station (an example shown in FIG. 7) can include a transceiver module configured to communicate with a radio system and plug into the radio system, such as aviation radio system of an aircraft.

The transceiver of the headset can be housed by a transceiver housing 110 coupled to a headset frame 120. The transceiver housing can be attached or integrated to a middle portion of the headset frame, as shown in FIG. 1, but this is not required. The transceiver housing can include other circuits and power supplies, such as a Bluetooth communication transceiver, an electrical storage device, amplifiers, and/or a codec (coder-decoder) module. The Bluetooth communication transceiver can provide an alternative means to communicate with a base station, which is independent of the wireless transceiver using the FM radio signal, or alternatively, can be configured to communicate with a separate device, such as a music player, cell phone, GPS system, etc. The electrical storage device, such as an electro-chemical battery or capacitor, can power the wireless transceiver, speaker(s), microphone, and other circuitry. The transceiver housing and/or headset frame can include an antenna (not shown) for receiving and/or transmitting a wireless signal for the wireless transceiver. Alternatively, the antenna can be integrated into the body of the transceiver housing and/or headset frame. The transceiver can include at least one switch assembly, such as a switch 112 shown on the transceiver housing in FIG. 1, for toggling power on and off for the transceiver and speaker. The switch assembly can be place anywhere on the frame accessible to the touch and reach of the user in normal operating conditions. The switch assembly and/or additional switch assemblies can provide control functions and other functions for the headset, which can be activated by the frequency of depressing the switch of the switch assembly, the duration of holding or releasing the switch, and/or combination of the frequency of depressing the switch and duration of holding the switch. For example, a separate switch or button may be present to activate a Bluetooth device connection, or alternatively, the Bluetooth device connection can be activated by pressing the single switch shown for a certain duration of time and/or by a certain frequency of switch depression.

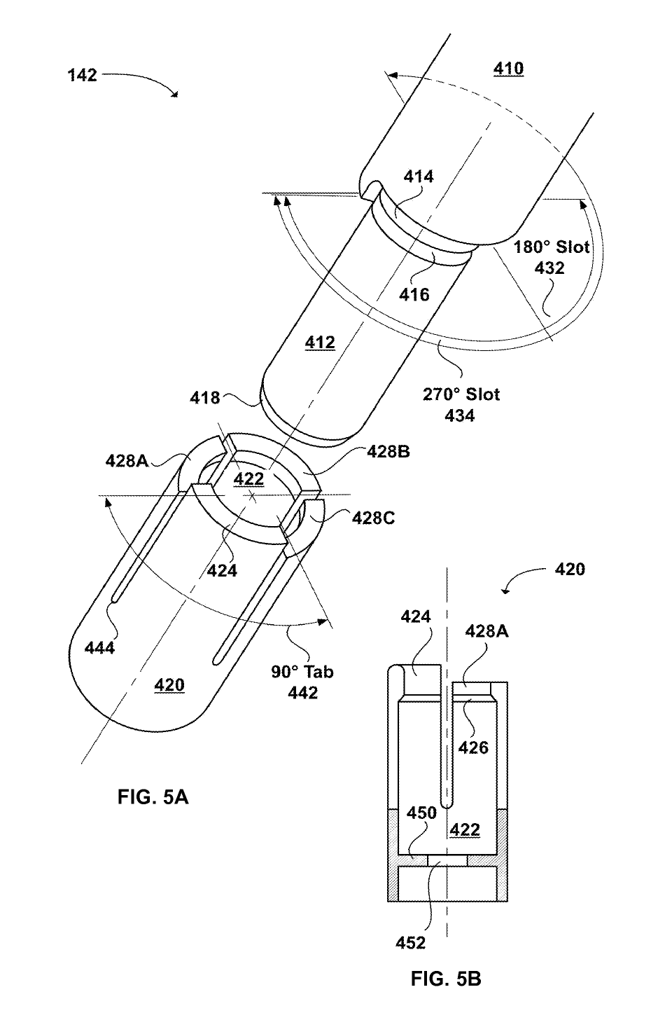

The headset 100 can include a thin wire-like frame 120 which can be contoured to fit on a user's head. The headset can include a middle portion configured to wrap around a back of the user's head. The headset frame can be adjustable to fit varying sizes and shapes of user heads. The headset can include one or more ear supports 140A and 140B for supporting the headset frame over the ears of the user. The ear support can be connected to the middle portion of the headset frame and configured to rest over an ear of the user's head. The ear support(s) can include respective end portions 144A and 144B extending downwardly generally in front of the ear. A microphone 150 on a microphone boom 152 can extend from an end portion of at least one ear support. The microphone boom can be flexible, as can a microphone boom joint 154. With the microphone boom and microphone boom joint positioned as shown, the user can speak into the microphone when placed on the head. However, when the microphone boom and joint are positioned so that the microphone points downwardly (extending essentially straight down from end portion 140A, when the headset is folded flat (as described in greater detail in FIG. 5), the microphone will also be in a coplanar configuration with the frame.

The headset 100 can also include a compressible polymeric foam insert 132A,132B that can be flexibly connected to the headset frame, which allows the insert to be positioned in the ear canal separately from the headset frame 120 being position on user's ears. The ear canal (external auditory meatus or external acoustic meatus) is a tube running from the outer ear to the middle ear. The human ear canal extends from the pinna to the eardrum and is about 35 millimeters (mm) in length and 5 to 10 mm in diameter. The insert can be attached to an ear insert support 130A and 130B. The compressible polymeric foam insert can be tapered and expand to fit the contours of a user's ear after being compressed. The insert can be threadably coupled to the ear insert support; however, other coupling techniques may also be used, such as pressure fitting, etc. In this example, the compressible polymeric foam insert provides passive noise reduction. Alternatively, rather than a tapered, expandable ear insert, a user may choose to have a customized ear piece made by molding the contours of the outer and middle ear. Such a customized molded ear insert does not typically provide as much noise reduction as the compressible polymeric foam inserts described herein, but some users may prefer to have a customized molded ear insert for other reasons. In each of these embodiments as well as others, the headset can provide at least 30 dBA of noise attenuation within the frequency range of 4 k to 6 k Hertz (Hz) for ambient sound in a high noise environment. Alternatively or additionally, the headset can provide at least 40 dBA of noise attenuation above 400 Hz for ambient sound in a high noise environment.

Some aviation headsets use active noise control (ANC) (also known as noise cancellation, active noise reduction [ANR] or antinoise) for reducing unwanted sounds. ANR headsets can be effective at low frequencies and can block noise selectively at target frequencies, but may be less effective for higher frequencies or the entire audible frequency range. Alternatively, passive noise control (or soundproofing) in headsets can block noise from being heard by the ear. Passive noise control or filtering can be more effective for higher frequencies and can cover a larger range of the audible frequencies. Passive noise control in headsets can also use less power than ANR headsets.

Sound can have both a loudness (amplitude) and pitch (frequency). The audible frequency range for humans is usually limited to frequencies between about 20 Hertz (Hz) and 20,000 Hz (20 kHz). Vowels can have a frequency around 400 Hz, which is lower than the 4-6 kilohertz (kHz) frequency for consonants. Since words are constructed with both the vowels and consonants, removing environmental and background noise in the frequencies occupied by vowels and consonants can improve the understandability in human speech and conversation in a high noise radio environment. ANR headsets can attenuate noise in the vowel frequencies and frequencies below the vowel frequencies (<400 Hz), but can be less effective in the consonant frequencies (>600 Hz). The compressible polymeric foam inserts 132A and 132B can provide at least 30 decibel (dBA) noise attenuation within a frequency range of 125 Hz to 10 kHz, which includes the consonant frequency range of 4 kHz to 6 kHz. The compressible polymeric foam insert can even provide noise attenuation of at least 40 dBA within a frequency range of 4 kHz to 6 kHz, or at least 40 dBA of noise reduction above 400 Hz for ambient sound in a high noise environment. An ANR headset may not even provide 25 dBA of noise attenuation within a frequency range of 4 kHz to 6 kHz, thus providing less noise cancellation in the audible frequency range and making conversation more difficult to understand in a high noise environment, such as an aviation environment. The decibel (dBA) is a logarithmic unit used to measure that indicates the ratio of a physical quantity (usually power or intensity) relative to a specified or implied reference level. A ratio in decibels is 10 times the base-10 logarithm of the ratio of two power quantities.

ANR is briefly described to illustrate the differences between passive noise control and ANR. Sound is a pressure wave, which can consist of a compression phase and a rarefaction phase. In ANR, a noise-cancellation signal can emit a sound wave via a speaker with the same amplitude but with inverted phase (also known as antiphase) to the original sound. The original sound wave can combine with the invert phase sound wave to form a new wave, in a process called interference. The invert phase sound wave effectively cancels out the original sound wave generating the noise, an effect which is called phase cancellation. Depending on the circumstances and the method used, the resulting sound wave may be so faint as to be inaudible to human ears.

In ANR, a speaker providing noise-cancellation can be co-located with the sound source to be attenuated. The noise-cancellation speaker can have the same audio power level as the source of the unwanted sound or noise. Alternatively, the transducer emitting the cancellation signal may be located at the location where sound attenuation is wanted (e.g. the user's ear in a headset). Emitting the cancellation signal at the user's ear can require a much lower power level for cancellation but may only be effective for a single user.

Active noise control can be achieved through the use of a computer, which analyzes the waveform of the background aural or nonaural noise, then generates a signal reversed waveform to cancel out the analyzed waveform by interference. The inverted waveform can have a similar or directly proportional amplitude to the waveform of the original noise providing a destructive interference that reduces the amplitude of the perceived noise.

The passive noise control differs from ANR by using unpowered mechanisms such as insulation or a muffler, instead of active power devices used in ANR devices, such as a headset. The compressible polymeric foam inserts 132A and 132B can use a soft polymeric retarded recovery foam that can be compressed to be freely insertable into a person's ear and allowed to recover to become wedged in the canal. A retarded recovery foam can be highly compressible with a slow, substantially complete recovery to the original shape (assuming no force applied on the foam, such as an ear canal). The compressible, resilient material used in the insert can be enhanced for comfort. The compressible polymeric foam insert can use a resilient, plasticized polymeric foam containing a sufficiently high concentration of organic plasticizer to provide the foam with a rate of recovery from 60 percent compression to 40 percent compression in from 1 to 60 seconds and an equilibrium pressure at 40 percent compression from 0.2 to 1.3 pounds per square inch (p.s.i.). The compressible polymeric foam can have a retarded recovery value of at least 4 seconds and no more than 45 seconds, with a useful range from 15 to 35 seconds. The compressible polymeric foam insert can be easy to use, easy to change, easy to manufacture, and comfortable to wear due to its conformability and yet reliably stays in place. The compressible polymeric foam insert can provide superior noise attenuation in the audible frequency range. The in-ear speakers or the compressible polymeric foam insert may include air vents open to the atmosphere. The compressible polymeric foam insert may provide air venting by flutes formed in the exterior surface of the insert. Alternatively, air venting can be provided by the ear insert support 130A and 130B. The air venting can reduce the amount of noise attenuation, but can allow the user to feel less plugged by the inserts and allow an equilibrium pressure between pressure in the ear canal and outside the ear canal.

The material for the compressible polymeric foam insert 132A and 1328 can include “Comply™” available from Hearing Components, Inc., or similar type material. The exterior surface of the compressible polymeric foam insert may include a skin of higher density cell structure than that of the interior of the insert. The skin may minimize ear wax penetration of the foam, provide water resistance to the foam, and generally improve the cleanliness of the foam. That being stated, other materials can be used for the polymeric foam inserts, as would be appreciated by one skilled in the art after considering the present disclosure.

Returning to FIG. 1, the headset 100 can include a swivel joint 142A and 142B (shown in greater detail in FIG. 5) which can rotatably connect an ear support 140A and 1408 to the middle portion of a headset frame 120. The ear supports can rotate approximately 90° with respect to the middle portion of the headset frame, which allows the headset to fold into a substantially flat configuration. The lightweight headset folded into a substantially flat configuration allows for the ease in stowing away, transporting, and storing the headset. A profile of the headset can have a thickness which is less than 4 times a thickness of the headset when in the headset's usable configuration. A profile of the headset can have a thickness which is less than 6 times a thickness of the headset when in the headset's usable configuration. Alternatively, the frame and microphone boom can be folded into a substantially flat configuration so that it is thinner in profile than the thickness of the housing 110. For example, the headset can extend 10 to 12 inches in an anteroposterior axis (anterior-posterior direction) when the microphone boom is extended. When folded, the headset can have a 1 to 2 inch thickness in the anteroposterior axis, where the microphone boom and ear supports are folded and substantially parallel to the dextro-sinistral axis (lateral plane). The anteroposterior axis can be perpendicular to the dextro-sinistral axis.

The swivel joint 142A and 1428 can also allow the headset to convert between a left-handed microphone boom and a right-handed microphone boom. The ear support can be configured to rotate approximately 180° with respect to the middle portion of the headset frame, which allows the headset to convert between a left-handed microphone boom and a right-handed microphone boom. A left-handed microphone boom can be a microphone boom positioned on the left side of the head, and right-handed microphone boom can be a microphone boom positioned on the right side of the head. Thus, the foldable headset provides for a headset that is less bulky than other aviation headsets and allows the headset to be adapted to a pilot's position in the cockpit.

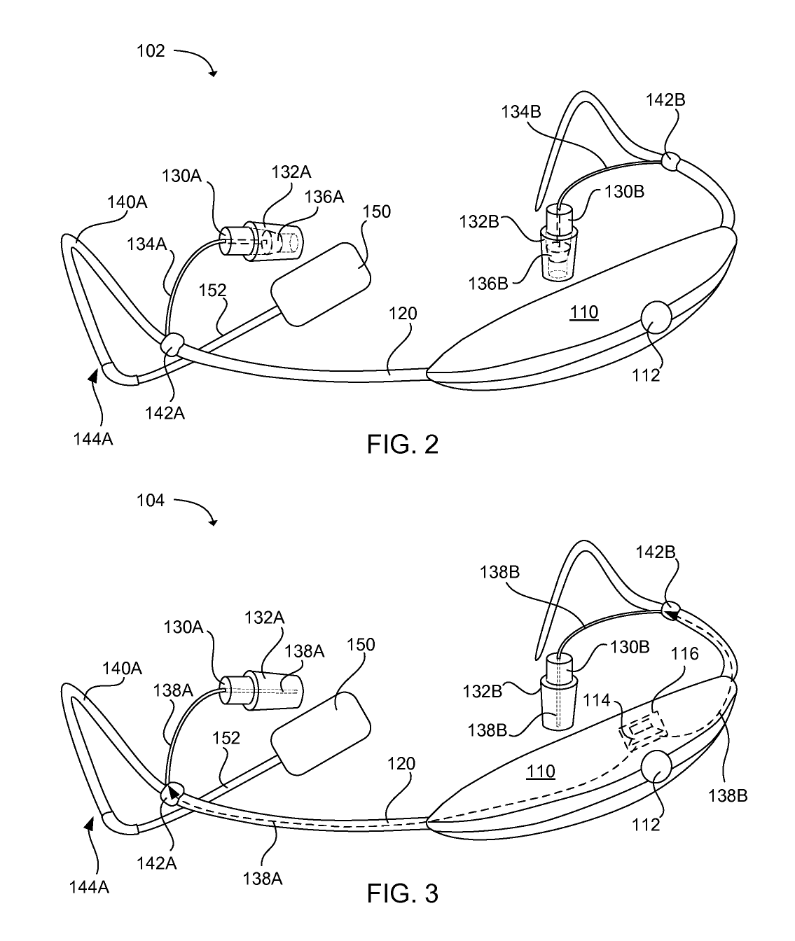

As shown in FIG. 2, the ear insert support 130A and 1308 of the headset 102 can include an in-ear speaker 136A and 136B, which is positioned within the compressible polymeric foam inserts 132A and 132B, which in turn can be positioned within the ear canal when in use. The in-ear speaker can be a hearing aid type speaker which can fit within an ear canal, draws a low amount of power, and provides high quality sound. The in-ear speaker can convert electrical signals into audible sound waves. The flexible connection 134A and 1348 between the ear insert support and the headset can include wiring and/or bus to power the speaker and provide electrical communication and coupling between the speakers and the transceiver (not shown, but present within housing 110), e.g., the wiring and/or bus can be included or housed with in a cavity of the headset frame 120. The flexible connection allows the insert to be positioned in the ear canal before or after positioning the ear supports on the user's ears. The insert can be disposable and/or replaceable when the insert becomes worn, soiled, or damaged.

It is noted that when referring to an “in-ear” speaker, that includes speakers that, when in use, are located with the cup of the outer ear. Thus, a speaker placed over the ear would not be considered an “in-ear” speaker. In one specific example, an “in-ear” speaker can be located within the middle ear or ear canal of a user.

The headset can include a second in-ear speaker. The in-ear speaker and second in-ear speaker can be configured to emit stereophonic sound or both speakers can emit monophonic sound. The headset can allow the mode to toggle between mono sound and stereo sound manually, or alternatively, the selection between stereo and mono can be provided automatically by an auto detection circuit based on a received speaker input signal.

Alternatively as illustrated in FIG. 3, the speaker 114 of the headset 104 can be included within the transceiver housing 110. The speaker can be present in a sound box 116. The headset frame 120, the ear insert supports 130A and 1308, and the compressible polymeric foam inserts 132A and 1328 can carry sound tubes 138A and 1388 (acoustic tube or acoustic passage) between the speaker and an openings in the ear insert supports and foam inserts. In the sound tube example, the ear insert support can provide support for the ear inserts and sound tubes, providing sound to both ears using a single speaker.

In both FIGS. 2 and 3, a microphone 150 and a microphone boom 152 can be integrated with headset where the microphone extends from an end portion 144A of a ear support 140A used to support the headset. The microphone boom can be flexibly connected to the ear support to allow the microphone to be adjusted to the face and mouth of the user.

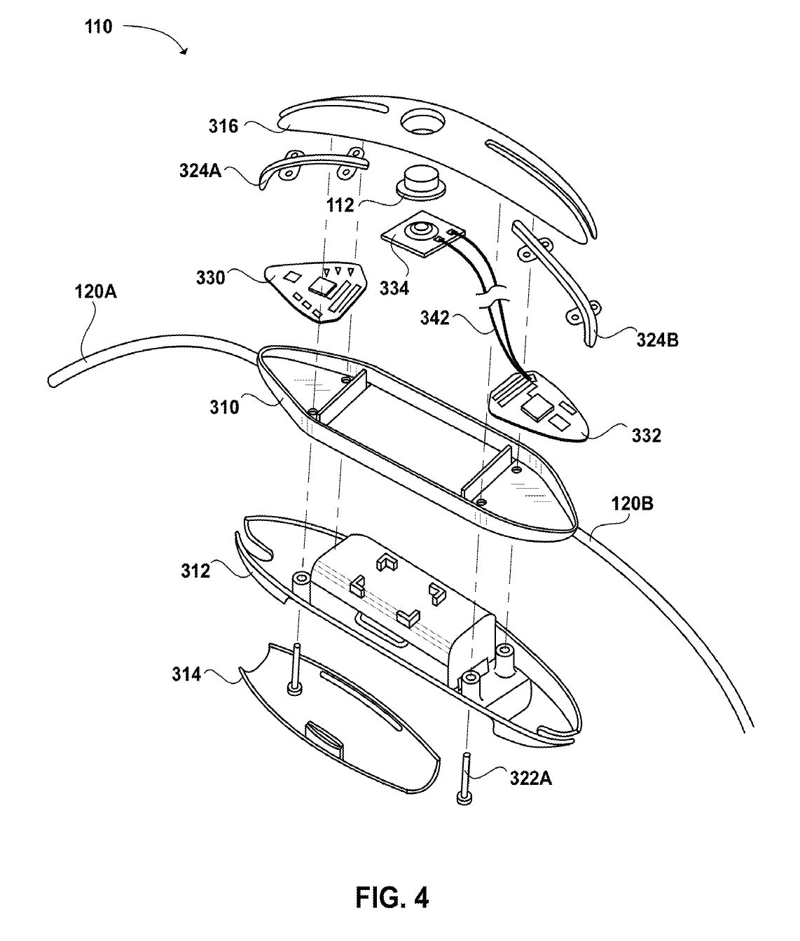

The headset can be powered by a power source (or an electrical storage device) within the transceiver housing 110, as shown in FIG. 4. Specifically, this FIG. illustrates a compartment 312 with a removable cover 314 for the electrical storage device included in the transceiver housing. The power source may be a self-contained power source, like an electrochemical device, e.g., a battery, or an electric device, e.g., a capacitor, supercapacitor, ultracapacitor, inductor, solar cell, or similar electrical device that can store or otherwise source energy. The self-contained power source may generate electrical power independently of power sources external to the headset using renewable energy sources including but not limited to devices using solar power. The transceiver housing can include solar cells to charge an electrical storage device. A wired headset can be provided by an independent power supply or draw power from the radio system.

Losing power to the headset during flight (or other critical task), especially during a take off or landing, can place the crew and aircraft in a dangerous situation when the pilot is communicating with air traffic control and navigating the plane around other planes. The headset can monitor the charge or energy of the electrical storage device and detect a low power condition. When a low power detection circuit detects a low power condition in the electrical storage device, an audible warning can alert the user of the headset of the low power condition. The low power detection circuit can be within the transceiver housing 110. The audible warning can provide an estimated time after which full power to the headset and functionality of the headset may be comprised. The audible warning may allow the pilot to replace or charge the electrical storage device before important events, such as a take off or landing. The audible warning can be provided to the speaker. The audible warning may be provided to one speaker allowing the second speaker to transmit the two-way communication. Other low power warning indicators, such a light or display, can also be used, but an audible signal can have an advantage over other low power warning indicators because the warning may be less likely to be ignored with other instruments and distractions commanding the attention of the pilot.

As discussed previously, the transceiver housing can include a wireless transceiver, a Bluetooth communication transceiver, an electrical storage device, an amplifier, a switch assembly 112 and 334, and/or a codec (coder-decoder) module. FIG. 4 illustrates components, such as integrated chips, integrated circuits (ICs), resistors, capacitors, and inductors, on printed circuit boards (PCBs) 330, 332, and 334. The wireless transceiver module, the Bluetooth communication transceiver, the amplifier, a portion of the switch assembly, and/or the codec module may be included in an IC. The PCB can be used to mechanically support and electrically connect electronic components using conductive pathways, tracks or signal traces etched from copper sheets laminated onto a non-conductive substrate. The PCB can include the transceiver, the codec, the digital signal processor (DSP), the memory, the amplifier, or the portion of a switch assembly used in a headset. The PCBs can be coupled together using a bus or wiring 342.

A transceiver housing base subframe 310 can be coupled to or integrated to a headset frame 120A and 120B. The transceiver housing can include top cover 316 to provide an aesthetic design and protect the components within the transceiver housing 110. The top cover can include a heat stake 324A and 324B to dissipate heat within the transceiver housing. The electrical storage device compartment 312, the transceiver housing base subframe, the top cover, and/or the heat stake can be coupled together with a screw, bolt, rivet, or other similar fastener 322A.

FIGS. 5A and 5B illustrate a swivel joint 142 which allows the headset to fold into a substantially flat configuration and/or convert between a left-handed microphone boom and a right-handed microphone boom. The swivel joint can use a barrel connection with a female connector (barrel or sleeve) 420 and a male connector (tip) 410. The female connector can include a tab 424 that protrudes from a plane on an end portion of the female connector formed by other connector sections 428A, 428B, and 428C. The connector can be divided into sections by slits 444 which allow the male connector to be inserted into an connector opening (or void) 422 of the female connector, snap into position, and removed from the female connector with the proper application of force. In the example of FIGS. 5A and 5B, the tab can be an approximately 90° arc 442. The female connector can have a ridge 426 in the sections and the tab to retain the male connector. The female connector can have a frame opening 452 to allow the wiring, the electrical bus, and/or the sound tube to pass through the swivel joint. The headset frame can be hollow providing a conduit or channel to allow the wiring, the electrical bus, and/or the sound tube to pass from the transceiver housing to the ear insert support. The female connector can have a stop 450 to limit the movement of the male connector in the axis parallel to the direction of insertion and removal.

The male connector 410 can include an opening (not shown) in the center to allow the wiring, the electrical bus, and/or the sound tube to pass through the swivel joint. The male connector can include a tip 412 with a smaller external diameter than the external diameter of a male connector body and/or the external diameter of the female connector body. The tip can include a taper (chamfer) 418 to allow a “lead-in” into the female connector. The male connector can include a groove 416 which can mate with the ridge 426 of the female connector providing retention of the male connector with the female connector. The male connector can include a shoulder 414 to receive the tab 424 of the female connector. The shoulder can include an approximately 180° slot 432, which can allow the swivel joint to rotate the ear supports approximately 90° with respect to the middle portion of the headset frame allowing the headset to fold into a substantially flat configuration. The 180° slot rotates approximately 90° because the tab utilizes the space of the other 90°. A tab with arc greater than or less than 90° can change the degree of allowable rotation. A slot greater than or less than 180° can also change the degree of allowable rotation. Alternatively, the shoulder can include an approximately 270° slot 434, which can allow the swivel joint to rotate the ear supports approximately 180° with respect to the middle portion of the headset frame allowing the headset to convert between a left-handed microphone boom and a right-handed microphone boom.

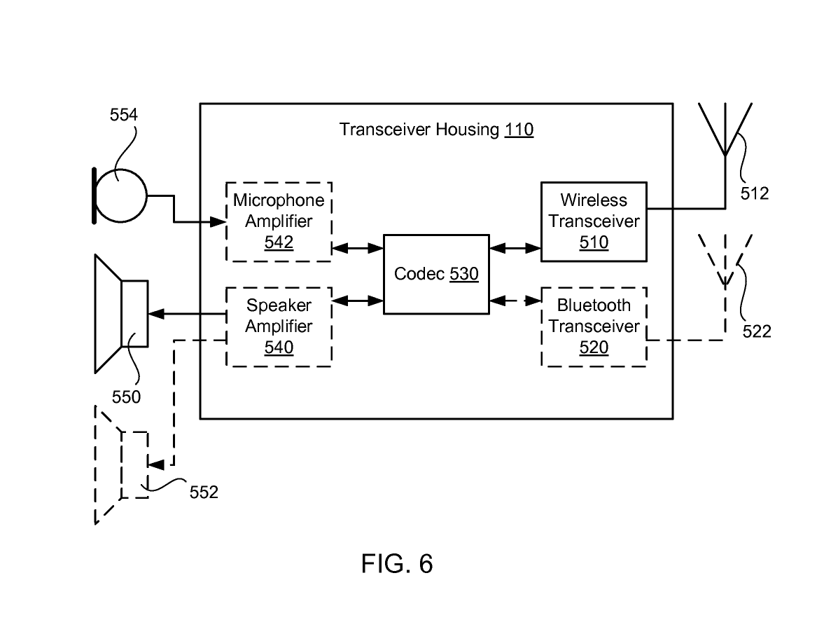

FIG. 6 illustrates some circuitry that can be used in a wireless headset, which can include an antenna 512 for receiving and transmitting a wireless signal with a base station. The antenna can be adapted to the wireless transceiver 510. Each transceiver can have a dedicated antenna, such as a FM wireless transceiver can use a FM antenna and a Bluetooth transceiver 520 can use a Bluetooth antenna 522. Alternatively, an antenna can be shared between different types of transceivers. The wireless transceiver module can convert between a radio frequency (RF) signal to a digital signal (input or output signal) or digital data stream, which can interface with a codec module 530. The wireless transceiver module can include a digital signal processor (DSP), a microcontroller or micro-control unit (MCU), memory, an oscillator, a modulator, a demodulator, an analog-to-digital converter (ADC), a digital-to-analog converter (DAC), an input/output (I/O) control unit, latches, and/or timers. The wireless transceiver module can include features provided by Texas Instruments (TI) CC2510Fx/CC2511Fx low-power System-on-Chip (SoC).

The wireless transceiver module 510 can be coupled to the codec module 530. A codec (coder-decoder) can be a device or computer program capable of encoding and/or decoding a digital data stream or signal. The codec can encode a data stream or signal for transmission, or decodes a received signal into a data stream. Codecs can include an analog-to-digital converter (ADC) converts analog signals into digital signals, a compressor for digital transmission, a decompressor, and/or a digital-to-analog converter (DAC). The codec module can provide low power stereo and mono audio input signal for a speaker 550 and 552. The codec module can convert a received digital data stream from the wireless transceiver into an amplified signal input for the speaker, such as the in-ear speaker. The codec module can convert a microphone transducer output signal into a digital data stream for transmission by the wireless transceiver. The codec module can include an amplifier, a clock, an oscillator, an ADC, a DAC, a DSP, a microcontroller, I/O control unit, and/or memory. A speaker amplifier 540 can be external to the codec and coupled to the codec and the speaker and/or the speaker amplifier can be integrated in the codec. A microphone preamplifier 542 can be external to the codec and coupled to the codec and the microphone 554 and/or the microphone preamplifier can be integrated in the codec. The codec module, microphone amplifier, and/or the speaker amplifier can include features provided by TI TLV320AIC26 low power stereo audio codec. The codec may store and provide the voice recording for the low battery warning or other audible control features. The transceiver housing can include the wireless transceiver module, the Bluetooth transceiver, the codec module, the microphone amplifier, the speaker amplifier, and/or the speaker (when sound tubes are used).

A single speaker can be used for monophonic sound. Two speakers can be used for stereophonic sound or monophonic sound. When monophonic sound is use by multiple speakers, the same signal can be transmitted to the multiple speakers. The speaker can include a low power hearing aid type speaker. The microphone can include a low power microphone.

The headset can communicate with a base station. As illustrated in FIG. 7, the base station can include a transceiver module 200 configured to plug in a radio system, such as aviation radio system of an aircraft. FIG. 7 illustrates a transceiver module with two male-type tip, ring, sleeve (TRS) connectors 232 and 234 for coupling the speaker and microphone to the aviation radio system. The TRS connector is a common analog audio connector that can also be called an audio jack, phone jack, phone plug, jack plug, stereo plug, mini-jack, mini-stereo, or headphone jack. Common sizes for a TRS connector are ¼″ and ⅛″, though other sizes can be used. For example, a microphone jack is of just a slightly different size as compared to a headphone jack in aviation systems. The TRS connector can be configured to plug in an airplane radio system. Another interface and connector can be provided for other radio systems. For example, a helicopter radio system can use a six pin interface. The connector can provide a connection which can be easily inserted and removed. The connector can be retained by the radio system with spring force.

The transceiver module 200 of the base station can include a flexible connection and/or wiring 236 and 238 to the connectors so the transceiver module can be positioned in a convenient location within a cockpit. The transceiver module can include an antenna and a wireless transceiver to transmitting and receiving communication from the wireless headset. The transceiver module can include a base station transceiver housing 210 which can house a base station wireless transceiver and other circuitry. The base station transceiver can be powered by the radio system, an electrical storage device, or other power mechanism. The base station transceiver housing can include at least one switch assembly for toggling power on the base station wireless transceiver. A first switch assembly 220 can toggle power on and off for the base station wireless transceiver and other circuitry within the base station transceiver housing, and the first switch assembly can provide a selector function when the power is on. A second switch assembly 222 and third switch assembly 224 can provide forward and reverse scrolling through options and/or volume control for the wireless headset. Alternatively, the volume control switches can be included on the headset. The base station transceiver housing can include at least one display 226 such as a liquid crystal display (LCD) or a light emitting diode (LED) for providing a status and/or an option, which can be selected.

When a message is not clearly understood, the base station or headset can replay the communication on the headset speakers. The replayed message can be activated by a switch on the headset or the base station. The base station or headset may be configured to store a short duration (e.g., 10 seconds) of a data stream in memory, which can be replay when desired. Replaying a message that was not clearly understood can facilitate communication, improve safety, and reduce the number of repeat instructions requested.

Various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques of the present disclosure. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, or other medium for storing electronic data. The base station and mobile station may also include a transceiver module, a counter module, a processing module, and/or a clock module or timer module. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executable of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “an embodiment” means that a particular feature, structure, or characteristic described in connection with the example is included in at least one embodiment of the present disclosure. Thus, appearances of the phrases “in an example” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description herein, numerous specific details are provided, such as examples of layouts, distances, network examples, etc., to provide a thorough understanding of embodiments of the disclosure. One skilled in the relevant art will recognize, however, that the teachings of the present disclosure can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the invention be limited, except as by the claims set forth below.

What is claimed is:

1. A wireless headset, comprising:
a headset frame;
a wireless transceiver coupled to the headset frame, wherein the wireless transceiver is configured to communicate with a base station; and
an in-ear speaker coupled to the wireless transceiver for converting electrical signals into sound waves.

2. The wireless headset of claim 1, wherein the in-ear speaker is positioned within an ear canal.

3. The wireless headset of claim 1, wherein the in-ear speaker is a hearing aid type speaker.

4. The wireless headset of claim 1, wherein the in-ear speaker is at least partially surrounded by a tapered foam insert.

5. The wireless headset of claim 1, wherein the in-ear speaker is at least partially surrounded or supported by a customized molded ear insert.

6. The wireless headset of claim 1, wherein the in-ear speaker is at least partially surrounded by a compressible polymeric foam insert.

7. The wireless headset of claim 6, wherein the compressible polymeric foam insert provides at least 30 decibel (dBA) noise attenuation within a frequency range of 4 k to 6 k Hertz (Hz) in a high noise environment.

8. The wireless headset of claim 6, wherein the compressible polymeric foam insert provides at least 40 decibel (dBA) noise attenuation above 400 Hz in a high noise environment.

9. The wireless headset of claim 6, wherein the compressible polymeric foam insert is threadably coupled to the in-ear speaker.

10. The wireless headset of claim 1, further comprising a second in-ear speaker, wherein the in-ear speaker and the second in-ear speaker are configured for emitting stereo sound.

11. The wireless headset of claim 10, further comprising an auto detection circuit for switching a speaker input signal between a mono input signal and a stereo input signal.

12. The wireless headset of claim 10, wherein the headset consumes less than 20 milliamp-hour of energy in full operational mode with the wireless transceiver receiving or transmitting signals and the in-ear speakers are emitting sound waves.

13. The wireless headset of claim 1, wherein the headset provides two-way communication.

14. The wireless headset of claim 1, wherein the headset is an aviation headset used in an aviation environment.

15. The wireless headset of claim 1, wherein the headset frame further comprises an ear support on an end of the headset frame for supporting the headset frame over an ear of a user.

16. The wireless headset of claim 15, further comprising a microphone boom extending from an end portion of the ear support.

17. The wireless headset of claim 15, wherein the ear support is configured to rotate at least about 90 degrees with respect to a middle portion of the headset frame, thereby enabling the wireless headset to fold into a substantially flat configuration.

18. The wireless headset of claim 15, wherein the ear support is configured to rotate at least about 180 degrees with respect to a middle portion of the headset frame, thereby enabling the wireless headset to convert between a left-handed microphone boom and a right-handed microphone boom.

19. The wireless headset of claim 1, wherein the headset frame is foldable, and wherein a profile of a folded headset has a thickness which less than 4 times a thickness of the headset when in the wireless headset's usable configuration.

20. The wireless headset of claim 1, wherein the wireless transceiver transmits and receives a frequency modulated (FM) radio signal.

21. The wireless headset of claim 20, wherein the FM radio signal is within a frequency band of 300 MHz to 5.6 GHz.

22. The wireless headset of claim 20, wherein the FM radio signal has an ultra high frequency (UHF) between 300 MHz and 3 GHz.

23. The wireless headset of claim 20, further comprising a Bluetooth communication transceiver for communicating with external Bluetooth devices, wherein the Bluetooth communication transceiver is independent of the wireless transceiver transmitting FM radio signals.

24. The wireless headset of claim 1, further comprising a transceiver housing for housing the transceiver.

25. The wireless headset of claim 24, further comprising a codec module in communication with the wireless transceiver to convert a received signal generated by the wireless transceiver into an amplified signal input for the speaker, wherein the codec module is within the transceiver housing.

26. The wireless headset of claim 24, further comprising an electrical storage device within the transceiver housing for powering the wireless transceiver and in-ear speaker.

27. The wireless headset of claim 26, the electrical storage device is an electro-chemical battery.

28. The wireless headset of claim 1, further comprising a low power detection circuit for detecting a low power condition and generating an audible warning via the in-ear speaker.

29. The wireless headset of claim 1, further comprising a switch assembly for powering the wireless transceiver and in-ear speaker.

30. The wireless headset of claim 1, wherein the switch assembly provides control functions for the wireless headset.

31. The wireless headset of claim 1, wherein the wireless headset weighs less than 2 ounces.

32. The wireless headset of claim 1, further comprising the base station.

33. The wireless headset of claim 32, wherein the base station is an aviation transceiver module configured to plug into an aviation radio system of an aircraft.

34. A wireless headset, comprising:
a headset frame;
a wireless transceiver coupled to the headset frame, wherein the wireless transceiver is configured to communicate with a base station;
a speaker configured for placement within or near the ear coupled to the wireless for converting electrical signals into sound waves; and
a codec module in communication with the wireless transceiver to convert a received signal generated by the wireless transceiver into an amplified signal input for the speaker.

35. The wireless headset of claim 34, wherein the speaker is an in-ear canal speaker.

36. A wireless headset, comprising:
a headset frame;
a pair of speakers coupled to the headset frame and configured for placement within ear canals of a user; and
a wireless transceiver coupled to the headset frame, wherein the wireless transceiver is configured to communicate with a base station and configured for converting electrical signals into sound waves at the pair of speakers,
wherein the headset consumes less than 20 milliamp-hour of energy in full operational mode with the wireless transceiver receiving or transmitting signals and the speakers emitting sound waves.

37. The wireless headset of claim 36, wherein the speakers are positioned at least partially within tapered foam inserts for substantially sealing with the ear canals for noise attenuation, thereby providing at least 30 dBA of noise attenuation within the frequency range of 4 k to 6 k Hertz (Hz) for ambient sound in a high noise environment.

38. The wireless headset of claim 36, wherein the speakers are positioned at least partially within tapered foam inserts for substantially sealing with the ear canals for noise attenuation, thereby providing at least 40 dBA of noise attenuation above 400 Hz for ambient sound in a high noise environment.

39. A wireless headset, comprising:
a headset frame;
a speaker coupled to the headset frame and configured for placement within an ear canal of a user; and
a wireless transceiver coupled to the headset frame, wherein the wireless transceiver is configured to communicate with a base station and configured for converting electrical signals into sound waves at the speaker,
wherein the speaker is positioned at least partially within a tapered foam insert for substantially sealing with the ear canal for noise attenuation, thereby providing at least 30 dBA of noise attenuation within the frequency range of 4 k to 6 k Hertz (Hz) for ambient sound in a high noise environment.

40. The wireless headset of claim 39, wherein the speaker is an in-ear canal speaker.

41. The wireless headset of claim 39, providing at least 40 dBA of noise attenuation above 400 Hz for ambient sound in a high noise environment.

42. A headset for two-way communication, comprising:
a headset frame comprising a middle portion configured to wrap around a back of a user's head, and an ear support connected to the middle portion and configured to rest over an ear of the user's head, the ear support including an end portion extending downwardly generally in front of the ear;
a pair of in-ear inserts attached to the headset frame, each being configured and positioned for placement within an ear canal;
at least one speaker positioned on the headset for delivering sound to the ear inserts; and
an adjustable microphone boom attached to the end portion of the headset frame, wherein the headset frame is swivelable at or near the ear support and is configured to rotate about 90 degrees with respect to the headset frame, thereby enabling the wireless headset to fold into a substantially flat configuration.

43. The headset of claim 42, wherein the ear support is configured to rotate about 180 degrees with respect to the headset frame, thereby enabling the wireless headset to convert between a left-handed microphone boom and a right-handed microphone boom.

44. The headset of claim 42, wherein the headset is a wireless headset.

45. The headset of claim 42, wherein the headset is a wired headset.

46. The headset of claim 42, wherein the at least one speaker is present in a sound box, and sound is delivered to the pair of ear inserts via acoustic tubes.

47. The headset of claim 42, wherein the at least one speaker is a pair of speakers that are positioned respectively at least partially within the pair of ear inserts.

48. The headset of claim 47, wherein the at least one speaker is a pair of speakers that are positioned respectively within a pair of ear canals.

49. The headset of claim 42, further comprising a second ear support connected to an opposite side of the middle portion and configured to rest over a second ear of the user's head, the second ear support including a second end portion extending downwardly generally in front of the second ear.

50. The headset of claim 42, wherein the in-ear inserts provide at least 30 dBA of noise attenuation within the frequency range of 4 k to 6 k Hertz (Hz) for ambient sound in a high noise environment.

51. The headset of claim 42, wherein the in-ear inserts provide at least 40 dBA of noise attenuation above 400 Hz for ambient sound in a high noise environment.
